(19) United States
(12) Patent Application Publication
(10) Pub. No.: US 2016/0063449 A1
(43) Pub. Date: Mar. 3, 2016

(54) METHOD AND SYSTEM FOR SCHEDULING A MEETING

(71) Applicant: FMR LLC, Boston, MA (US)

(72) Inventors: Colin Duggan, County Mayo (IE); Patrick Finn, East Walpole, MA (US); James Wagstaff, Co. Galway (IE); Kevin Burke, Co. Galway (IE)

(21) Appl. No.: 14/471,451

(22) Filed: Aug. 28, 2014

(51) Int. Cl. G06Q 10/10

(52) U.S. Cl. CPC G06Q 10/1095

(57) ABSTRACT

A method is provided for scheduling a meeting. The method includes receiving a request from an organizer to schedule a meeting, executing a constraint satisfaction algorithm to determine at least one meeting data set comprising a value for at least one variable in a set of variables. The meeting data set defines at least one of a proposed time, room or participants for the meeting. Executing the constraint satisfaction algorithm involves performing a backtracking search within a solution domain to determine the meeting data set for the set of variables that satisfies a set of meeting constraints. If no meeting data set is determined, the set of variables and the solution domain can be revised. A next backtracking search can be performed to determine the meeting data set for the revised set of variables in the revised solution domain that satisfies one or more of the meeting constraints.

### FIELD OF THE INVENTION

The invention generally relates to computer-implemented methods and apparatuses, including computer program products, for scheduling a meeting. More specifically, the invention relates to an electronic application for scheduling a meeting using optimization and/or natural intelligence algorithms and processes.

### BACKGROUND OF THE INVENTION

A variety of electronic calendaring and notification software applications exist for scheduling a meeting for multiple participants. However, these programs have a number of limitations. For example, after an organizer sends an electronic meeting invite to the participants, the organizer needs to wait to receive a response from each participant before knowing whether the planned time and/or location is feasible. If one or more of the participants have conflicts, the organizer needs to manually determine a new time and/or location that works for everyone, which can be a complex and time consuming process, especially when there is a large number of participants involved.

Existing programs such as Microsoft Outlook® offer a variety of calendar specific capabilities, such as the ability to organize meetings, including manage invitee lists and allow users to share their calendars. However, these applications have a number of limitations. For example, they do not take into consideration of conference room availability and other location-based features when scheduling a meeting, such as determining whether there is at least one conference room available to host a meeting at the desired time and location. In addition, existing applications cannot automatically recommend one or more alternative solutions for scheduling a meeting room if the desired meeting criteria cannot all be met.

Therefore, there is a need for managing electronic scheduling by considering a variety of factors, including conference room resources and alternative solutions.

### SUMMARY OF THE INVENTION

Methods and apparatuses are provided to optimize electronic meeting scheduling by taking into consideration of various meeting criteria. The methods and apparatuses address deficiencies in today's electronic scheduling applications by recommending scheduling solutions to a meeting organizer that satisfy one or more of the meeting criteria in order of their priorities. Hence, the methods and apparatuses of the present technology can determine alternative solutions to a scheduling request in the event that all of the meeting criteria cannot be satisfied. An artificial intelligence technique, such as a constraint satisfaction algorithm, can be used to implement the scheduling schemes of the present technology.

In one aspect, a computer-implemented method is provided for scheduling a meeting. The method includes receiving, by a computing device, a request over a computer network from an organizer to schedule a meeting, where the request comprises a desired set of meeting criteria including identities of participants, a desired time frame, a desired location, and a minimum number of the participants desired to hold the meeting. The method also includes receiving, by the computing device, a ranking of the set of meeting criteria from the organizer to indicate their relative importance. The method further includes executing, by the computing device, a constraint satisfaction algorithm to determine at least one meeting data set comprising a value for at least one variable in a set of variables. The meeting data set defines at least one of a proposed time, room and participants for the meeting. Execution of the constraint satisfaction algorithm includes the steps of (a) determining, by the computing device, availability data for each of the participants within or about the desired time frame and availability data of potential rooms within or about the desired time frame; and (b) formulating, by the computing device, (1) a solution domain defined by the availability data of the participants and the availability data of the potential rooms, (2) the set of variables, and (3) a set of meeting constraints. Execution of the constraint satisfaction algorithm also includes (c) performing, by the computing device, a backtracking search within the solution domain to determine the meeting data set for the set of variables that satisfies the meeting constraints. If no meeting data set is determined, execution of the constraint satisfaction algorithm further includes the steps of (d) generating, by the computing device, a revised set of variables by removing at least one variable from the set of variables based on the ranking and a revised solution domain; (e) performing, by the computing device, a next backtracking search within the revised solution domain to determine the meeting data set for the revised set of variables that satisfies one or more of the meeting constraints; and (f) repeating, by the computing device, steps (d) and (e) until (1) the meeting data set is found for the revised set of variables or (2) the revised set includes a number of variables less than a threshold. The meeting data set from the constraint satisfaction algorithm is recommended to the organizer via a graphical user interface.

In another aspect, a computer-implemented system is provided for scheduling a meeting. The system includes an input module for receiving a request over a computer network from an organizer to schedule a meeting. The request comprises a desired set of meeting criteria including identities of participants, a desired time frame, a desired location, and a minimum number of the participants desired to hold the meeting. The input module is further configured to receive a ranking of the set of meeting criteria from the organizer The system also includes a calculation module for executing a constraint satisfaction algorithm to determine at least one meeting data set comprising a value for at least one variable in a set of variables. The meeting data set defines at least one of a proposed time, room and participants for the meeting. The calculation module is configured to: (a) determine availability data for each of the participants within or about the desired time frame and availability data of potential rooms within or about the desired time frame; and (b) formulate (1) a solution domain defined by the availability data of the participants and the availability data of the potential rooms, (2) the set of variables, and (3) a set of meeting constraints. The calculation module is also configured to: (c) perform a backtracking search within the solution domain to determine the meeting data set for the set of variables that satisfies the meeting constraints. If no meeting data set is determined, the calculation module is adapted to perform: (d) generate a revised set of variables by removing at least one variable from the set of variables based on the ranking and a revised solution domain; (e) perform a next backtracking search within the revised solution domain to determine the meeting data set for the revised set of variables that satisfies one or more of the meeting constraints; and (f) repeat steps (d) and (e) until (1) the meeting data set is found for the revised set of variables or (2) the revised set of variables includes a number of variables less than a threshold. The computer-implemented system further includes a recommendation module for recommending the meeting data set from the constraint satisfaction algorithm to the organizer via a graphical user interface.

In yet another aspect, a computer program product, tangibly embodied in a non-transitory computer machine-readable storage device, is provided for scheduling a meeting. The computer program product including instructions being operable to cause data processing apparatus to receive a request over a computer network from an organizer to schedule a meeting. The request comprises a desired set of meeting criteria including identities of participants, a desired time frame, a desired location, and a minimum number of the participants desired to hold the meeting. In addition, a ranking of the set of meeting criteria is received from the organizer,. The data processing apparatus is caused to execute a constraint satisfaction algorithm to determine at least one meeting data set comprising a value for at least one variable in a set of variables. The meeting data set defines at least one of a proposed time, room and participants for the meeting. This process comprises the steps: (a) determine availability data for each of the participants within or about the desired time frame and availability data of potential rooms within or about the desired time frame; (b) formulate (1) a solution domain defined by the availability data of the participants and the availability data of the potential rooms, (2) the set of variables, and (3) a set of meeting constraints. The data processing apparatus is also caused to: (c) perform a backtracking search within the solution domain to determine the meeting data set for the set of variables that satisfies the meeting constraints. If no meeting data set is determined, the data processing apparatus is caused to perform the steps: (d) generate a revised set of variables by removing at least one variable from the set of variables based on the ranking and a revised solution domain; (e) perform a next backtracking search within the revised solution domain to determine the meeting data set for the revised set of variables that satisfies one or more of the meeting constraints; and (f) repeat steps (d) and (e) until (1) the meeting data set is found for the revised set of variables or (2) the revised set of variables includes a number of variables less than a threshold. The data processing apparatus is further caused to recommend the meeting data set from the constraint satisfaction algorithm to the organizer via a graphical user interface.

In other examples, any of the aspects above can include one or more of the following features. In some embodiments, the availability data of the participants is normalized based on the organizer's time zone. In some embodiments, the availability data of the participants are determined from one or more electronic calendars. The availability data of each of the participants can comprise a plurality of times the participant is available from the current time to the end of day of the desired time frame.

In some embodiments, the availability data of the potential rooms is determined from one or more electronic booking systems. The availability data of each of the potential rooms can comprise a plurality of times the potential room is available from the current time to the end of day of the desired time frame.

In some embodiments, execution of the constraint satisfaction algorithm further comprises: (g) if the revised set of variables includes a number of variables less than the threshold, determining, by the computing device, the meeting data set to include a room with conferencing capability. The conferencing capability can comprise video or audio equipment.

In some embodiments, the threshold value can be received from the organizer to specify the minimum number of variables in the revised set of variables.

In some embodiments, multiple meeting data sets can be recommended to the organizer via the graphical user interface. Each of the meeting data sets is determined from the solution domain and satisfies the meeting constraints.

In some embodiments, an identity of at least one optional participant within the participants is specified by the organizer The constraint satisfaction algorithm can be executed to determine whether at least one meeting data set can be determined that accommodates all the participants, including the at least one optional participant. If the at least one meeting data set cannot be determined that accommodates all the participants, the constraint satisfaction algorithm is re-executed without accounting for the availability of the at least one optional participant.

### BRIEF DESCRIPTION OF THE DRAWINGS

The advantages of the technology described above, together with further advantages, may be better understood by referring to the following description taken in conjunction with the accompanying drawings. The drawings are not necessarily to scale, emphasis instead generally being placed upon illustrating the principles of the technology.

FIG. 1 shows an exemplary scheduling system within an illustrative network environment.

FIG. 2 shows an exemplary flow chart for scheduling a meeting.

FIG. 3 shows a flow chart depicting a general process flow associated with determining a meeting data set.

FIG. 4 shows an exemplary backtrack process.

### DESCRIPTION OF THE INVENTION

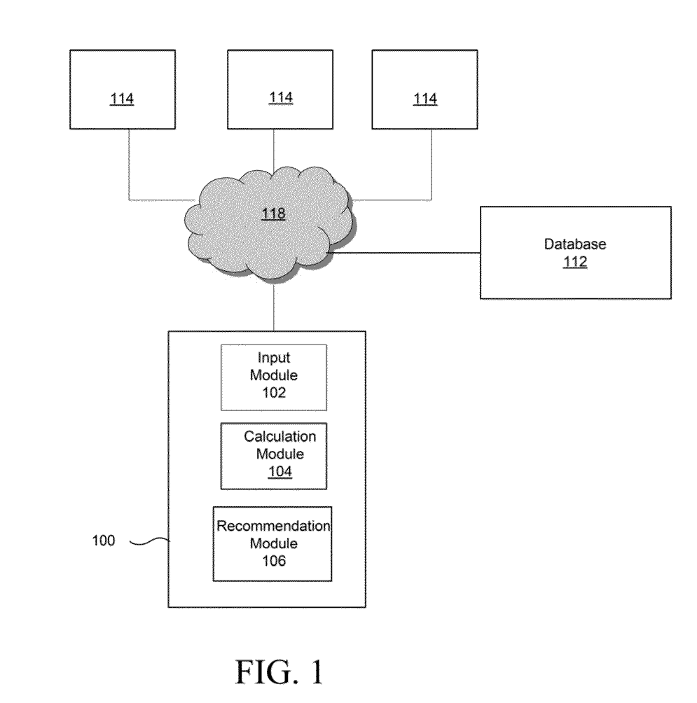

FIG. 1 shows an exemplary scheduling system within an illustrative network environment. The network environment includes multiple user devices 114 configured to communicate with the scheduling system 100 via an IP network 118, such as a LAN, WAN, cellular network, or the Internet. A client application installed on each of the user devices 114 allows the user to schedule a meeting with the scheduling system 100, view details associated with a proposed meeting recommended by the scheduling system 100, and accept or decline a meeting invite issued by the scheduling system 100. Each of the user devices 114 can be a computing device operated by a user. A computing device refers to any device with a processor and memory that can execute instructions. Computing devices include, but are not limited to, personal computers, server computers, portable computers, laptop computers, personal digital assistants (PDAs), e-Readers, cellular telephones, e-mail clients, tablets and other mobile devices.

The scheduling system 100 can also interact with at least one database 112 via the IP network 118 to retrieve or store pertinent data for each user. For example, the database 112 can maintain one or more electronic calendars for employees of a business enterprise and one or more electronic booking systems for rooms associated with the business enterprise, based on which the scheduling system 100 can determine the availability of each employee and/or room. In some embodiments, the electronic calendars and room booking systems are integrated with the scheduling system 100.

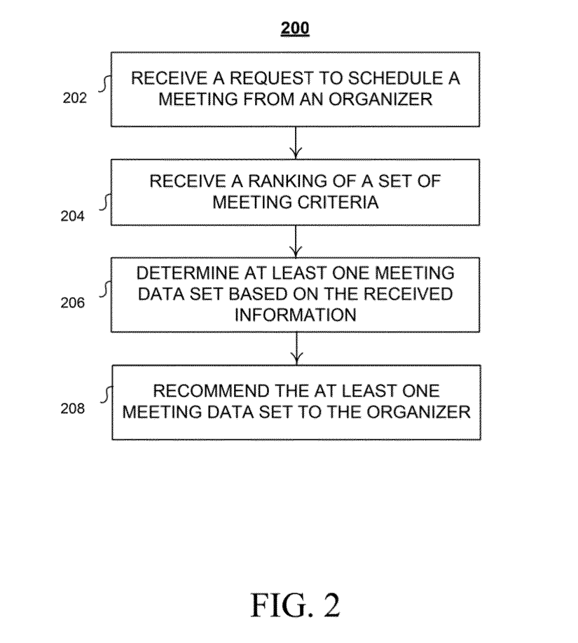

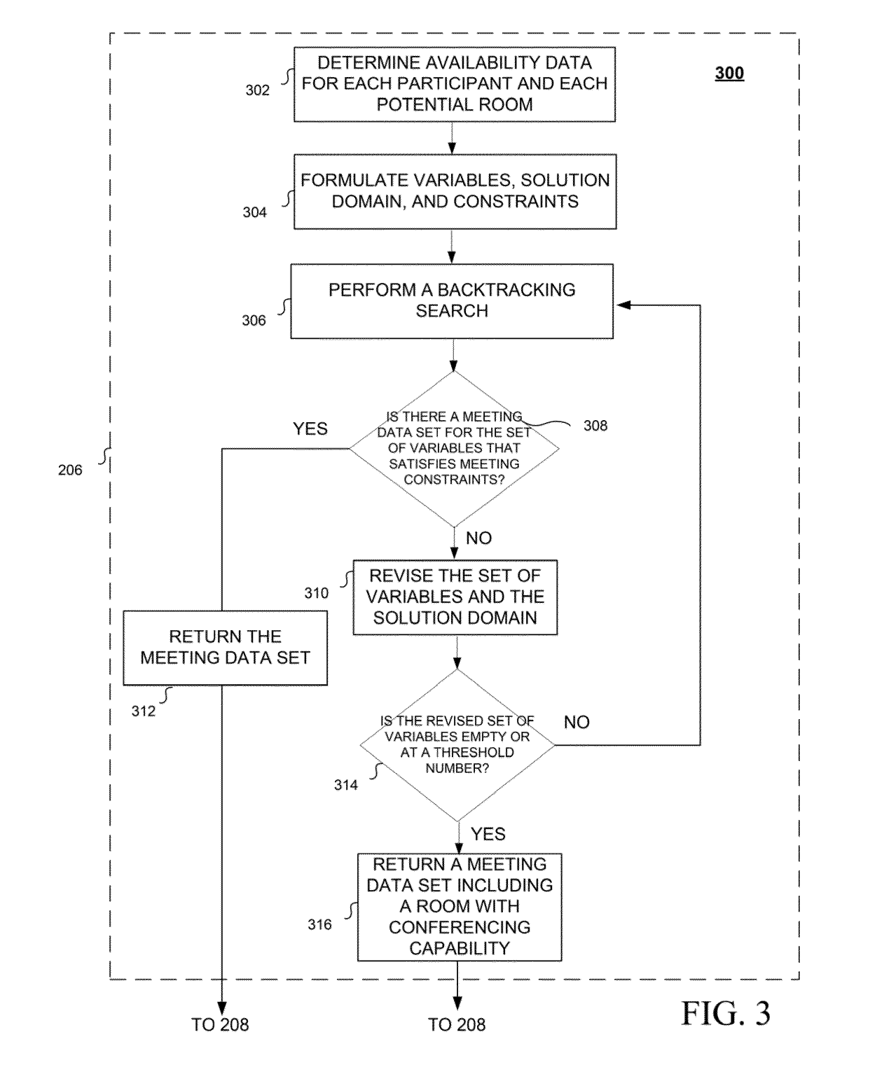

The scheduling system 100 includes a combination of hardware modules for implementing processes and/or software of the present technology. For example, the scheduling system 100 can be executed on one or more hardware devices to implement the exemplary processes of FIGS. 2 and 3. As shown, the scheduling system 100 includes an input module 102, a calculation module 104, and a recommendation module 106.

The input module 102 of the scheduling system 100 can comprise a graphical user interface (GUI) configured to handle user access (e.g., login and/or logout), user administration (e.g., any of the administration functions associated with the support and/or management of the system 100), widget management (e.g., providing the end user with the capability to arrange and save preferences for display of data within the browser area), and/or other GUI services. For example, a user can provide, through the input module 102, a request to schedule a meeting, where the request specifies a desired set of meeting criteria including identities of one or more desired participants, a desired time frame, a desired location, and a minimum number of the participants desired to hold the meeting. In some embodiments, the user can also specify, via the input module 102, a ranking of the meeting criteria to indicate their relative priorities in a scheduling determination.

The calculation module 104 can determine at least one meeting data set for recommendation to a user based on the information supplied by the user through the input module 102. The meeting data set defines at least one of a proposed time, a proposed conference room, or the identities of one or more participants for the meeting. The calculation module 104 can determine this meeting data set by implementing an artificial intelligence algorithm, such as a constraint satisfaction algorithm. In the case that the algorithm is unable to determine a solution that satisfy all of the user-specified criteria, the calculation module 104 can determine a meeting data set that satisfy at least one of the criteria. In the case that the algorithm is unable to determine a solution that satisfy any of the user-specified criteria, the calculation module 104 can determine a meeting data set that includes a room with conferencing capability so that every participant can attend the meeting, either in person or on a telecommunication basis. Thus, even if one or more of the desired meeting criteria cannot be met, the calculation module 104 can still provide the user with a next-best solution.

The recommendation module 106 can be configured to recommend to the user the meeting data set determined by the calculation module 104, such as through a graphical user interface. The recommendation module 106 can also send a meeting invite to the participants and/or automatically reserve a meeting room based on the recommended meeting data set.

FIG. 2 shows an exemplary flow chart 200 depicting a general process for scheduling a meeting. The elements of the flow chart 200 are described using the exemplary scheduling system 100 of FIG. 1. The process can include receiving a request to schedule a meeting from a meeting organizer (step 202), receiving a ranking of a set of meeting criteria associated with the request from the organizer (step 204), determining at least one meeting data set based on the received information (step 206), and recommending the meeting data set to the organizer (step 208).

An organizer can submit a request to schedule a meeting to the scheduling system 100 (step 202). The request can supply a set of meeting criteria that include, for example, the identities of participants for the meeting, a desired time frame, a desired location, and a minimum number of participants desired to hold the meeting. The organizer can specify the meeting criteria via the input module 102 of the scheduling system 100 by interacting with, for example, a client application installed on his or her user device 114.

The desired time frame supplied by the organizer can include a date, a starting time, an ending time, a duration limit, or any combination thereof. At least one of the date, starting time, ending time or duration limit can be associated with a particular time zone, which can be specified by the user or automatically set as the time zone of the meeting organizer

The desired location provided by the organizer can include a building number or facility associated with a business enterprise, a city or state where the business enterprise has a corporate presence, or any other physical location where a meeting can be held. The desire location can also include a specific room or a group of rooms that can be used to host the meeting.

The organizer can also enter the identity of each participant who is required to attend the meeting and/or the identity of each optional participant whose availability does not affect whether the meeting can be held. The scheduling system 100 can automatically determine the capacity of a room needed to host the meeting based on the number of required participants supplied by the organizer. Alternatively, the organizer can explicitly specify the capacity of the desired room for hosting the meeting. In addition, the organizer can specify other amenities desired for the room, such as one or more of : tables, chairs, blackboard, overhead projector, television, video camera, video conferencing equipment, video cassette recorder (VCR), video disc (DVD) payer, compact disc (CD) player, computer, network lines, phone, fax, sound system, telecommunication equipment, access to a wireless network, and the likes. Furthermore, the organizer can specify catering options for the room, ranging from light refreshments to actual meals.

After or concurrently with receiving the request containing the meeting criteria (step 202), the scheduling system 100 can also receive from the organizer (step 204) a ranking of the meeting criteria. Specifically, the organizer can rank the meeting criteria in accordance with their relative importance from high to low priority. As an example, the organizer can specify that satisfying the time criterion (e.g., starting the meeting at a desired time) is more important than having the minimum number of participants attending the meeting, which is more important than holding the meeting at a desired location. The ranking can be on a numerical scale, with the lowest number corresponding to the criterion of the highest priority and the highest number corresponding to the criterion of the lower priority, or vice versa.

Upon receiving the request, including the meeting criteria (from step 202) and a ranking of the meeting criteria (from step 204), the scheduling system 200 can proceed to determine at least one meeting data set for recommendation to the organizer based on the received information. The meeting data set can define at least one of a proposed time, a proposed room, or a list of recommended participants for the meeting. FIG. 3 shows a flow chart 300 depicting a general process flow associated with determining the meeting data set, which includes determining the availability data for each participant and for each potential room (step 302), formulating a set of one or more variables, a set of one or more meeting constraints, and a solution domain defined by the availability data of the participants and the availability data of the potential rooms (step 304), and performing a backtracking search within the solution domain to determine the meeting data set for the set of variables that satisfies the set of meeting constraints (step 306). If a meeting data set is determined from the backtracking search (step 308), the meeting data set is supplied (step 312) to step 208 of FIG. 2 for recommendation to the organizer Otherwise, a revised set of variables and a revised solution domain is generated (step 310). If the revised set of variables is not empty or includes a number of variables greater than or equal to a threshold provided by the organizer (step 314), a next backtracking search is performed (repeat step 306) within the revised solution domain to determine a meeting data set for the revised set of variables that satisfies one or more of the meeting constraints. Steps 306, 308 and 310 can be repeated until (i) a meeting data set is found within the revised solution domain for the revised set of variables (step 312), (ii) the revised set of variables becomes empty (step 314) or (iii) the revised set includes a number of variables less than the threshold (step 314). If the revised set of variables is empty or has a number of variables less than the threshold, a meeting data set that includes a room with conferencing capability can be located (step 316) and supplied to step 208 of FIG. 2 for recommendation to the organizer.

At step 302, availability data for each participant and for each potential room is determined. The availability data can be automatically determined by the scheduling system 100 by interacting with one or more electronic calendars associated with the participants or one or more electronic booking systems associated with the potential rooms. Each of the electronic calendars or booking systems can be maintained by a business enterprise to automatically track availability information, such as indicating whether a person or room is available or unavailable at a particular time. These electronic calendars or booking systems can be integrated with the scheduling system 100 or provided by an outside vendor (e.g., Microsoft outlook®). The availability data for each of the identified participants can indicate one or more times the participant is available at normal business hours within a window of the desired meeting time. For example, the availability data of a participant can indicate when the person is available ±24 hours from the desired meeting time or from the time of scheduling to the end of business day of the desired meeting time. This window can be specified by the meeting organizer or provided as a default setting in the scheduling system 100.

Similarly, the availability date of a potential room can indicate one or more times the room is available at normal business hours within a window of the desired meeting time, such as within ±24 hours from the desired meeting time or from the time of scheduling to the end of business day of the desired meeting time. In some embodiments, each potential room is a room specified by the meeting organizer In some embodiments, each potential room is a room automatically determined by the scheduling system 100 that is at a user-specified location (e.g., a building own by the business enterprise) and/or close to the user-specified location (e.g., in a neighboring building). Optionally, the scheduling system 100 can further filter the potentials rooms to determine those that have the minimum capacity and/or desired equipment specified by the organizer

The participants and the potential rooms can be located at different time zones in comparison to the meeting organizer In this situation, the availability data (i.e., the times when the participants or the potential rooms are available) can be normalized based on a standard time zone, which can be the time zone of the meeting organizer or a user-specified time zone. Therefore, if the participants are in different geographical regions, the scheduling system 100 can use the organizer's time zone as the base time to calculate the local time for each of the participants. As an example, if the organizer is based in the U.S. and in the eastern standard time (EST) zone and he suggests a meeting time of 11 am, the availability of a participant who is based in Ireland is shown as between 4-5 pm Greenwich Mean Time (GMT).

An artificial intelligence algorithm, such as a constraint satisfaction algorithm, can be used to implement the scheduling schemes of the present technology. Constraint satisfaction programming typically states the problem as a number of variables, formulates a solution domain imposed by one or more meeting constraints (step 304), and performs a search (e.g., a backtracking, constraint propagation or local search) within the solution domain (step 306) to determine values of the variables. Hence, a solution to a constraint satisfaction problem is adapted to assign values to a set of variables from a solution domain to satisfy a set of meeting constraints. Programming language used to implement the constraint satisfaction algorithm can include: C++, B-Prolog, CHIP V5, Ciao Prolog, ECLiPSe, SICStus Prolog, GNU Prolog, Oz programming language, YAP Prolog, SWI Prolog, Claire programming language, Curry programming language, and Turtle programming language. Other algorithms that can be used to implement the scheduling schemes include, for example, genetic algorithm, heuristic search algorithm, integer programming, branch and bound algorithm, dynamic programming and greedy algorithm.

At step 304, the scheduling system 100 defines one or more meeting variables determined based on the meeting criteria supplied by the organizer in a scheduling request (from step 202). For example, the meeting variables can include one or more of: a time variable representing a starting time of the meeting, a room variable representing a room for hosting the meeting, a participants variable presenting participants identified to attend the meeting, and a minimum capacity variable representing the minimum capacity for the chosen meeting room. In some embodiments, the scheduling system 100 provides a ranking of the variables based on the ranking of the meeting criteria supplied by the organizer (from step 204). For example, if the organizer specifies that starting the meeting at a desired time is most important, followed by finding a room with the capacity to satisfy the minimum number of participants, followed by having all the identified participants attending the meeting, and followed by locating a room at a desired location to hold the meeting, then the ranking of the variables from the most important to the least important becomes the time variable, the minimum capacity variable, the participants variables, and the room variable.

At step 304, the scheduling system 100 also defines a solution domain by enumerating possible values for each of the variables. For the time variable, the set of possible values can be a window from the desired meeting time. For example, the possible values can be hours in a normal working day within a 24-hour period of the desired meeting time. For the room variable, the set of possible values can include the availability data of the potential rooms, which indicate the times each of the potential rooms are available within a given duration (from step 302). For the participants variable, the set of possible values can include the availability data of the participants for the meeting, which indicate the times the participants are available within a given duration (from step 302). The possible values for the participants variable can include availability information for the required participants and, optionally, availability information for the optional participants. For the minimum capacity variable, the set of possible values can include the availability data of the potential rooms having the minimum capacity specified by the organizer (from step 302).

At step 304, the scheduling system 100 can further define a set of constraints based on the meeting criteria supplied by the organizer (from step 202). One constraint on the time variable T can be T=x, where x represents the desired meeting time or time range specified by the organizer. One constraint on the room variable R can be R=T, specifying that the chosen meeting room needs to be available at the meeting time set for the variable T. One constraint on the participants variable P can be P=R, specifying that the participants need to be available at the same time the meeting room is available. Another constraint on the participants variable P can be P=T, specifying that the participants need to be available at the meeting time set for the variable T. Yet another constraint on the participants variable P can be P≧y, where y represents a minimum attendance number specified by the meeting organizer

At step 306, the scheduling system 100 performs a search within the solution domain to determine a value for each variable in the set of variables (e.g., the time variable, the participants variable, the room variable and the minimum capacity variable) that satisfies all the meeting constraints. Even though a backtracking search is described herein, other search algorithms compatible with constraint satisfaction programming are equally applicable, including, but not limited to, constraint propagation or local search. In backtracking, incremental attempts are made to extend a partial solution towards a complete solution. This is done by incrementally building candidates to the complete solution, and abandoning each partial candidate (“backtracks”) as soon as the algorithm determines that the partial candidate cannot possibly be completed for a valid solution.

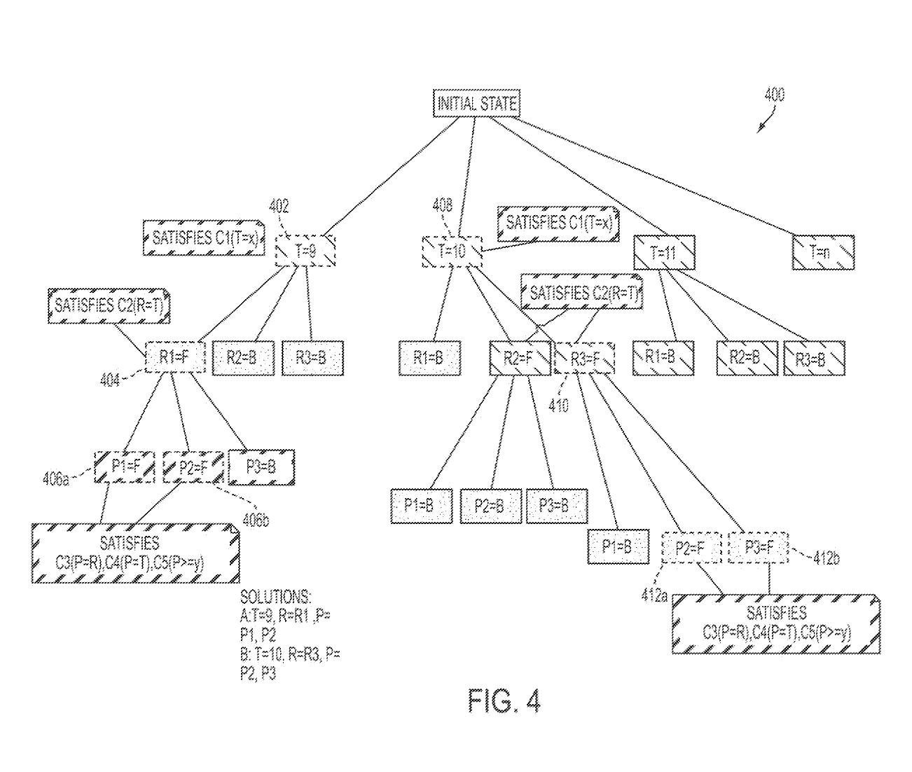

FIG. 4 shows an exemplary backtracking process. In this example, the solution domain is composed of possible values for the time variable (T=9 or 10), possible values for the room variable (R=R1, R2 and R3, where each room is associated with a set of availability data), and possible values for the participants variable (P=P1, P2 and P3, where each participant is associated with a set of availability data). As shown in FIG. 4, the backtrack process 400 first tries to expand a solution at the first possible time slot given, which is 9 am (step 402). As this time slot satisfies the constraint T=x, where x represents the desired meeting time or time range specified by the organizer, the process 400 then checks the availability of each room at this time. Room R1 satisfies the constraint R=T (step 404), indicating that the room is available at the desired time slot. The search process 400 next checks if any of the participants are available. P1 and P3 satisfy the constraint P=T (steps 406a and 406b), indicating that these participants are available at the desired time slot. Therefore one solution is found. The process 400 next checks T=10 (step 408), which also satisfies the constraint T=x. The process 400 expands the search to rooms R2 and R3, both of which satisfy the constraint R=T. However, none of the participants under room R2 satisfy the constraint of P=T. Therefore, the process backtracks to room R3 (step 410). Under room R3, participants P2 and P3 (steps 412a and 412b) satisfy the constraint P=T and are added to the list of solutions. The process 400 can look to expand the search to T=11, but this violates the constraint T=x. Thus, the algorithm stops.

Returning to the process 300 of FIG. 3, if a backtracking search within the solution domain cannot determine a set of values for all of the variables that satisfy all the meeting constraints (step 308), the scheduling system 100 can proceed to generate a revised set of variables and a revised solution domain (step 310) that are used to locate a meeting room. Specifically, the scheduling system 100 can generate the revised variable set by eliminating from the original variable set the variable that corresponds to the lowest priority ranking. Accordingly, the solution domain can be revised by eliminating the space corresponding to the eliminated variable. In some embodiments, the original set of constraints is also revised by eliminating those constraints corresponding to the eliminated variable. If the revised set of variables is not empty or includes a number of variables greater than or equal to a threshold value provided by the organizer (step 314), the scheduling system 100 performs another backtracking search (repeat step 306) to attempt to locate a conference room by assigning a value to each variable in the revised set of variables from the revised solution domain that satisfy one or more of the constraints, such as those in the revised set of constraints. Steps 306, 308, 310 and 314 can be repeated until values for the revised set of variables are determined. As an example, if the capacity variable is ranked the lowest importance out of the four variables time, room, participants and capacity, the scheduling system can attempt to find a meeting room that does not take into consideration of the size of the room, but is available at the desired meeting time, can be reached by the participants, and has the necessary equipment. This removes from the solution domain the space that corresponds to the capacity variable, thereby increasing the size of the solution space from which the meeting data set can be chosen.

If a meeting data set is found (step 312), where the meeting data set includes a values for each of the variables either in the original variable set or in a revised variable set, the scheduling system 100 can return the meeting data set to the recommendation module 106 for recommendation to the organizer (to step 208). However, if no meeting data set is found, even after the original set of variables has been successively reduced, the scheduling system 100 proceeds to determine an alternative solution (step 314). For example, the scheduling system 100 can locate a room with conferencing capability (e.g., video and/or audio communication equipment) such that those who cannot attend the meeting in person can join remotely. The conference room can be located at the desired location specified by the organizer and/or reserved for a time when most of the participants are available, even if it is not necessarily at the desired meeting time specified by the organizer In some embodiments, instead of locating a room for the meeting, the scheduling system 100 can schedule an audio and/or video conference among the participants based on the availability of the participants shown on their electronic calendars. The scheduling system 100 can automatically circulate a dial-in number and dial-in code for a call or a link for a WebEx Session. Hence, no room is suggested in this case.

In some embodiments, multiple meeting data sets can be found from each backtracking search. Each meeting data set can include a proposed time, room, room capacity and participants determined from a solution domain (either original or revised) that satisfies a set of constraints (either original or revised). The scheduling system 100 can recommend the multiple meeting data sets to the organizer via the recommendation module 106.

In some embodiments, the organizer can specify the identity of at least one optional participant for the meeting. In this case, the scheduling system 100 can run the constraint satisfaction process 300 to determine whether at least one meeting data set can be determined that accommodates all the participants, including the optional participant. If no meeting data set is found, the process 300 can be re-executed to remove the optional participants one at a time to determine if a meeting data set can be found. Therefore, if there are optional participants present and a meeting data set cannot be determined in the original solution domain, removal of data corresponding to these optional participants from the solution domain takes precedence over successive removal of data corresponding to any of the variables.

The above-described techniques ensure that a meeting is electronically scheduled based on a set of user-defined meeting criteria. Specifically, computer software is created to schedule a meeting by defining a meeting time, a meeting location (e.g., a room) and a list of participants for the meeting using optimization and/or natural intelligence algorithms and processes. Scheduling the meeting involves several factors including determining availability data of the desired participants within or about the desired time frame for the meeting, determining availability data of potential rooms within or about the desired time frame, analyzing a ranking of the user-defined meeting criteria, and determining at least one set of meeting time, location and participants that can optimally satisfy one or more of the meeting criteria in order of their priorities.

Thus, the above-described techniques can automatically and optimally determine alternative solutions to a meeting schedule request in the event that not all of the meeting criteria can be satisfied. In contrast, today's scheduling applications are incapable of automatically recommending one or more alternative solutions for scheduling a meeting room if the desired meeting criteria cannot all be met. Hence, the present technology provides a process of scheduling a meeting (created with the aid of an artificial intelligence technique) that addresses deficiencies in today's electronic scheduling technology. Furthermore, the present invention can reduce overall processing time on a host system for scheduling a meeting in comparison to existing electronic scheduling applications because the present technology can effectively and efficiently schedule a meeting by automatically accommodating many potentially conflicting constraints including room availability, other location-based availabilities, and attendee availability. Hence, the subject invention prevents a user from having to repeatedly reschedule a meeting with an existing application using different combinations of constraints until a satisfactory solution is found, which can be a processing-intensive task.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system (e.g., a cloud-computing system) that includes any combination of such back-end, middleware, or front-end components. The above described techniques can be implemented as a Software-As-A-Service (SaaS) model or using a multi-tiered approach.

Communication networks can include one or more packet-based networks and/or one or more circuit-based networks in any configuration. Packet-based networks can include, for example, an Ethernet-based network (e.g., traditional Ethernet as defined by the IEEE or Carrier Ethernet as defined by the Metro Ethernet Forum (MEF)), an ATM-based network, a carrier Internet Protocol (IP) network (LAN, WAN, or the like), a private IP network, an IP private branch exchange (IPBX), a wireless network (e.g., a Radio Access Network (RAN)), and/or other packet-based networks. Circuit-based networks can include, for example, the Public Switched Telephone Network (PSTN), a legacy private branch exchange (PBX), a wireless network (e.g., a RAN), and/or other circuit-based networks. Carrier Ethernet can be used to provide point-to-point connectivity (e.g., new circuits and TDM replacement), point-to-multipoint (e.g., IPTV and content delivery), and/or multipoint-to-multipoint (e.g., Enterprise VPNs and Metro LANs). Carrier Ethernet advantageously provides for a lower cost per megabit and more granular bandwidth options.

Devices of the computing system can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer, mobile device) with a world wide web browser (e.g., Microsoft® Internet Explorer® available from Microsoft Corporation, Mozilla® Firefox available from Mozilla Corporation).

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed:

1. A computer-implemented method for scheduling a meeting, the method comprising:
receiving, by a computing device, a request over a computer network from an organizer to schedule a meeting, the request comprising a desired set of meeting criteria including identities of participants, a desired time frame, a desired location, and a minimum number of the participants desired;
receiving, by the computing device, a ranking of the set of meeting criteria from the organizer to indicate their relative importance;
executing, by the computing device, a constraint satisfaction algorithm to determine a meeting data set comprising a value for at least one variable in a set of variables, the meeting data set defining at least one of a proposed time, room or participants for the meeting, wherein execution of the constraint satisfaction algorithm comprises:
a. determining, by the computing device, availability data for each of the participants within or about the desired time frame and availability data of potential rooms within or about the desired time frame;
b. formulating, by the computing device, based on the meeting criteria (1) a solution domain defined by the availability data of the participants and the availability data of the potential rooms, (2) the set of variables and (3) a set of meeting constraints;
c. performing, by the computing device, a backtracking search within the solution domain to determine the meeting data set for the set of variables that satisfies the set of meeting constraints;
d. if no meeting data set is determined, generating, by the computing device, a revised set of variables by removing at least one variable from the set of variables based on the ranking and a revised solution domain;
e. performing, by the computing device, a next backtracking search within the revised solution domain to determine the meeting data set for the revised set of variables that satisfies one or more of the meeting constraints; and
f. repeating, by the computing device, steps d and e until (1) the meeting data set is found for the revised set of variables or (2) the revised set of variables includes a number of variables less than a threshold; and
recommending, by the computing device, the meeting data set to the organizer via a graphical user interface.

2. The computer-implemented method of claim 1, further comprising normalizing the availability data of the participants based on the organizer's time zone.

3. The computer-implemented method of claim 1, wherein the availability data of the participants are determined from one or more electronic calendars.

4. The computer-implemented method of claim 1, wherein the availability data of each of participants comprise a plurality of times the participant is available from the current time to the end of day of the desired time frame.

5. The computer-implemented method of claim 1, wherein the availability data of the potential rooms is determined from one or more electronic booking systems.

6. The computer-implemented method of claim 1, wherein the availability data of each of the potential rooms comprise a plurality of times the potential room is available from the current time to the end of day of the desired time frame.

7. The computer-implemented method of claim 1, wherein execution of the constraint satisfaction algorithm further comprises: (g) if the revised set of variables includes a number of variables less than the threshold, determining, by the computing device, the meeting data set including a room with conferencing capability.

8. The computer-implemented method of claim 7, wherein the conferencing capability comprises video or audio equipment.

9. The computer-implemented method of claim 1, further comprising receiving, by the computing device, the threshold from the organizer specifying the minimum number of variables in the revised set of variables.

10. The computer-implemented method of claim 1, further comprising recommending, by the computing device, a plurality of meeting data sets to the organizer via the graphical user interface, wherein each of the plurality of meeting data sets is determined from the solution domain and satisfies the set of meeting constraints.

11. The computer-implemented method of claim 1, further comprising:
receiving, by the computing device, an identity of at least one optional participant within the participants; and
executing, by the computing device, the constraint satisfaction algorithm to determine whether at least one meeting data set can be determined that accommodates all the participants, including the at least one optional participant.

12. The computer-implemented method of claim 11, further comprising re-executing the constraint satisfaction algorithm without accounting for the availability of the at least one optional participant if the at least one meeting data set cannot be determined that accommodates all the participants.

13. A computer-implemented system for scheduling a meeting, the system comprising:
an input module for receiving a request over a computer network from an organizer to schedule a meeting, the request comprising a desired set of meeting criteria including identities of participants, a desired time frame, a desired location, and a minimum number of the participants desired, wherein the input module is further configured to receive a ranking of the set of meeting criteria from the organizer;
a calculation module for executing a constraint satisfaction algorithm to determine at least one meeting data set comprising a value for at least one variable in a set of variables, the meeting data set defining at least one of a proposed time, room or participants for the meeting, wherein the calculation module is configured to:
a. determine availability data for each of the participants within or about the desired time frame and availability data of potential rooms within or about the desired time frame;
b. formulate based on the meeting criteria (1) a solution domain defined by the availability data of the participants and the availability data of the potential rooms, (2) the set of variables, and (3) a set of meeting constraints;
c. perform a backtracking search within the solution domain to determine the meeting data set for the set of variables that satisfies the set of meeting constraints;
d. if no meeting data set is determined, generate a revised set of variables by removing at least one variable from the set of variables based on the ranking and a revised solution domain;
e. perform a next backtracking search within the revised solution domain to determine the meeting data set for the revised set of variables that satisfies one or more of the meeting constraints; and
f. repeat steps d and e until (1) the meeting data set is found for the revised set of variables or (2) the revised set of variables includes a number of variables less than a threshold; and
a recommendation module for recommending the meeting data set to the organizer via a graphical user interface.

14. The computer-implemented system claim 13, wherein the calculation module is further configured to normalize the availability data of the participants based on the organizer's time zone.

15. The computer-implemented system of claim 13, wherein the availability data for each of the participants comprise a plurality of times the participant is available from the current time to the end of day of the desired time frame.

16. The computer-implemented system of claim 13, wherein the availability data for each of the potential rooms comprise a plurality of times the potential room is available from the current time to the end of day of the desired time frame.

17. The computer-implemented system of claim 13, wherein the recommendation module is further configured to: (g) if the revised set of variables includes a number of variables less than the threshold, determine the meeting data set including a room with conferencing capability.

18. The computer-implemented system of claim 13, wherein the input module is further configured to receive the threshold from the organizer specifying the minimum number of variables in the revised set of variables.

19. A computer program product, tangibly embodied in a non-transitory computer machine-readable storage device, for scheduling a meeting, the computer program product including instructions being operable to cause data processing apparatus to:
receive a request over a computer network from an organizer to schedule a meeting, the request comprising a desired set of meeting criteria including identities of participants, a desired time frame, a desired location, and a minimum number of the participants desired;
receive a ranking of the set of meeting criteria from the organizer;
execute a constraint satisfaction algorithm to determine at least one meeting data set comprising a value for at least one variable in a set of variables, the meeting data set defining at least one of a proposed time, room and participants for the meeting, wherein execute the constraint satisfaction algorithm comprises:
a. determine availability data for each of the participants within or about the desired time frame and availability data of potential rooms within or about the desired time frame;
b. formulate based on the meeting criteria (1) a solution domain defined by the availability data of the participants and the availability data of the potential rooms, (2) the set of variables and (3) a set of meeting constraints;
c. perform a backtracking search within the solution domain to determine the meeting data set for the set of variables that satisfies the set of meeting constraints;
d. if no meeting data set is determined, generate a revised set of variables by removing at least one variable from the set of variables based on the ranking and a revised solution domain;
e. perform a next backtracking search within the revised solution domain to determine the meeting data set for the revised set of variables that satisfies one or more of the meeting constraints; and
f. repeat steps d and e until (1) the meeting data set is found for the revised set of variables or (2) the revised set of variables includes a number of variables less than a threshold; and
recommend the meeting data set to the organizer via a graphical user interface.
